(19) United States
(12) Patent Application Publication
(10) Pub. No.: US 2023/0381044 A1
(43) Pub. Date: Nov. 30, 2023

(54) SURGICAL POSITIONING SYSTEM

(71) Applicant: Maaz Meah, Glen Ellyn, IL (US)

(72) Inventor: Maaz Meah, Glen Ellyn, IL (US)

(21) Appl. No.: 18/353,765

(22) Filed: Jul. 17, 2023

Related U.S. Application Data
(63) Continuation-in-part of application No. 16/059,757, filed on Aug. 9, 2018, now Pat. No. 11,701,281.
(60) Provisional application No. 62/543,606, filed on Aug. 10, 2017.

(51) Int. Cl. A61G 13/12

(52) U.S. Cl. CPC A61G 13/1295; A61G 13/1235; A61G 13/127

(57) ABSTRACT

A positioning system for securing a patient relative to a surgical table is provided. The system may include a pad body, a plurality of pad straps and a plurality of body straps. The pad body may include an upper body portion, a lower body portion with first and second lower body extensions, and first and second arm extensions corresponding to the respective first and second lower body extensions. The plurality of pad straps may be configured to be positioned through at least one of the upper body and lower body portions. The plurality of body straps and the plurality of pad straps may be configured to engage each other. The system may include a support strip to increase friction and resist movement relative to the surgical table. A method of a positioning system is also provided.

### CROSS-REFERENCE TO RELATED APPLICATIONS

This Non-Provisional Application is a continuation-in-part of and claims priority to Non-Provisional application Ser. No. 16,059,757 filed Aug. 9, 2018, which is based on and claims priority to U.S. Provisional Patent Application No. 62/543,606 filed on Aug. 10, 2017, each of which is hereby incorporated by reference in its entirety.

### BRIEF DESCRIPTION OF THE DRAWINGS

While the claims are not limited to a specific illustration, an appreciation of the various aspects is best gained through a discussion of various examples thereof. Referring now to the drawings, exemplary illustrations are shown in detail. Although the drawings represent illustrations of various embodiments, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows:

FIG. 1 illustrates a perspective view of an exemplary positioning system of the present disclosure;

FIG. 2 illustrates a front view of the exemplary positioning system of FIG. 1;

FIG. 3 illustrates a rear view of the exemplary positioning system of FIG. 1;

FIG. 4 illustrates a closer view of the exemplary positioning system including, for example, a strap and buckle assembly;

FIG. 5 illustrates a closer view of the exemplary positioning system including, for example, a strap assembly;

FIG. 6 illustrates a top view of an exemplary strap assembly of FIG. 5;

FIG. 7 illustrates a top view of an exemplary strap and buckle assembly of FIG. 4;

FIG. 8 illustrates a closer view of an exemplary strap assembly of the present disclosure;

FIG. 9 illustrates a closer, rear view of the exemplary positioning system;

FIG. 10 illustrates a view of a strap assembly of the present disclosure;

FIG. 11 illustrates a perspective view of another exemplary positioning system of the present disclosure;

FIG. 12 illustrates a perspective view of the exemplary positioning system of FIG. 11;

FIG. 13 illustrates a perspective view of the exemplary positioning system of FIG. 11;

FIG. 14 illustrates a top, perspective view of the exemplary positioning system of FIG. 11;

FIG. 15 illustrates a bottom, perspective view of the exemplary positioning system of FIG. 11;

FIG. 16 illustrates a front view of an exemplary positioning system of the present disclosure;

FIG. 17 illustrates a rear view of the exemplary positioning system of FIG. 16;

FIG. 18 illustrates a front view of another exemplary positioning system of the present disclosure;

FIG. 19 illustrates a rear view of the exemplary positioning system of FIG. 18;

FIG. 20 illustrates a top view of an exemplary strap and buckle assembly of FIGS. 18-19;

FIG. 21 illustrates a top view of an exemplary strap and buckle assembly of FIGS. 18-19;

FIG. 22 illustrates a closer view of an exemplary strap assembly of the present disclosure;

FIG. 23 illustrates a top view of a strap assembly of the present disclosure;

FIG. 24 illustrates a front view of the strap assembly of FIG. 24;

FIG. 25 illustrates a perspective view of another exemplary positioning system of the present disclosure;

FIG. 26 illustrates a perspective view of another exemplary positioning system of the

present disclosure;

FIG. 27 illustrates a front view of the exemplary positioning system of FIG. 25;

FIG. 28 illustrates a rear view of the exemplary positioning system of FIG. 25;

FIG. 29 illustrates a front view of the exemplary positioning system of FIG. 26;

FIG. 30 illustrates a rear view of the exemplary positioning system of FIG. 26;

FIG. 31 illustrates a closer view of an exemplary positioning system including, for example, a strap and buckle assembly;

FIG. 32 illustrates a top view of an exemplary strap and buckle assembly of FIGS. 25-26;

FIG. 33 illustrates a top view of another exemplary strap and buckle assembly of FIGS. 25-26; and

FIG. 34 illustrates a top view of a strap assembly of FIGS. 25-26;

FIG. 35 illustrates a front, perspective view of an exemplary positioning system of the present disclosure;

FIG. 36 illustrates a closer view of the exemplary positioning system of FIG. 35;

FIG. 37 illustrates a closer view of the exemplary positioning system of FIG. 35;

FIG. 38 illustrates a closer view of the exemplary positioning system of FIG. 35;

FIG. 39 illustrates a rear, perspective view of the exemplary positioning system of FIG. 35;

FIG. 40 illustrates a front view of the exemplary positioning system of FIG. 35; and

FIG. 41 illustrates a rear view of the exemplary positioning system of FIG. 35.

### DETAILED DESCRIPTION

A positioning system may be configured for positioning a patient on a surgical table during a surgical or medical procedure. The positioning system may be configured for robotic, laparoscopic, open, or minimally invasive surgery. The positioning system may be configured to secure the patient to the table while in a Trendelenburg, reverse Trendelenburg, or lateral tilt position. The positioning system may include a pad body, an anti-skid strip, and a plurality of pad and body straps to secure the pad body and patient relative to the table. The pad body may include or be attached to waist and a n supports configured to engage the waist, one arm, or both arms of the patient or any combination thereof. The positioning system may include a foam, latex-free high density, high viscosity, capillary action, or water wicking material or any combination thereof.

The pad body may include an upper extension, an upper body or chest portion, a lower body or waist portion, and a bottom recess. The pad body may include a plurality of slots or holes for receiving a first pad strap through the upper body or chest portion, a second pad strap through the lower body or waist portion, a third pad strap through the lower body or waist portion, and one or a plurality of body or chest straps configured to engage and connect respective first and second ends of the first, second, and third pad straps. The system may include a first buckle on a first portion of the second pad strap, a second buckle on a second portion of the second pad strap, a third buckle on a first portion of the third pad strap, and a fourth buckle on a second portion of the third pad strap. The system may include a support strip attached to the pad body, e.g., by way of stitching and/or an adhesive. The support ship may include an anti-slip tape or a textured surface with perforations, ribs, dimples, bumps, or a lattice structure. The support strip may be positioned transverse to the first, second, and third pad straps. Any of the pad or body straps may include a fastening side with a hook and loop fastener.

A positioning system may include a pad body, first, second, and third pad straps, a plurality of body straps, and/or a support strip. The pad body may have a longitudinal axis and first and second transverse ends on opposing sides of the longitudinal axis. The pad body may include an upper body portion with an upper extension, a lower body portion having first and second lower body extensions, first and second arm extensions corresponding to the respective first and second lower body extensions, a bottom recess in the lower body portion, or a combination thereof. The first, second, and third pad straps may be configured to be respectively positioned through the upper and/or lower body portions. The plurality of body straps may be configured to engage at least one of the first, second, and/or third pad straps. The support strip may be attached to the pad body and forming channels to receive at least one of the first, second and/or third pad straps between the pad body and the support strip.

The first and second lower body extensions may be configured to be positioned between a waist of a patient and respective first and second arms of the patient. The first and second arm extensions may be respectively connected to the first and second lower body extensions such the first arm extension and first lower body extension are connected to and configured to extend from the first transverse end to wrap around the first arm of the patient, and the second arm extension and second lower body extension are connected to and configured to extend from the second transverse end to wrap around the second arm of the patient. The support strip may be attached along the longitudinal axis of the pad body and transverse to the first, second, and third pad straps.

The first arm extension and the first lower body extension form a first common end that is connected to and extends in a first bifurcated configuration from the first transverse end of the pad body, the first common end sharing a common edge with the first lower body extension and the first transverse end of the pad body, and the second arm extension and second lower body extension form a second common end that is connected to and extends in a second bifurcated configuration from the second transverse end of the pad body. The second common end may share a common edge with the second lower body extension and the second transverse end of the pad body.

A positioning system may include a pad body, a first pair of arm extensions, and a second pair of arm extensions. The pad body may include a longitudinal axis, a rear side, a front side, and first and second transverse ends on opposing sides of the longitudinal axis. The pad body may include first and second longitudinal adjustment strips on the rear side and respectively adjacent the first and second transverse ends. The first pair of arm extensions may adjustably extend from the first longitudinal adjustment strip and along each other in a first direction relative to the longitudinal axis. The second pair of arm extensions may adjustably extend from the second longitudinal adjustment strip and along each other in a second direction relative to the longitudinal axis.

Methods of providing and using a positioning system are also contemplated. A method may include providing a pad body including an upper extension, an upper body or chest portion, a lower body or waist portion, and a bottom recess. The method may further include positioning a first pad strap through and relative to the upper body or chest portion, a second pad strap through and relative to the lower body or waist portion, and a third pad strap through and relative to the lower body or waist portion. The method may further include positioning one or a plurality of body or chest straps so as to connect respective first and second ends of the first, second, and third pad straps.

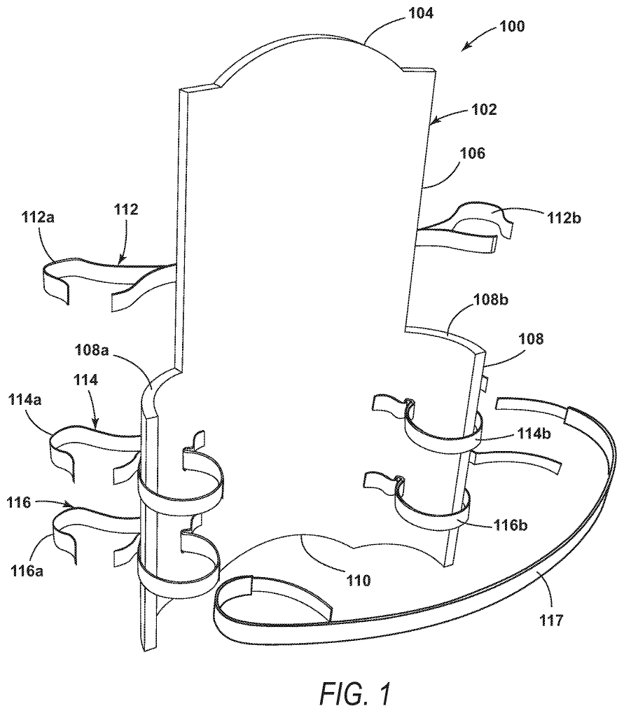

FIGS. 1-3 illustrate an exemplary positioning system 100. System 100 may include a pad body 102. Pad body 102 may be made of a flexible material such as foam, e.g., medical grade foam. As shown in FIG. 1, pad body 102 may include an upper extension 104, an upper body or chest portion 106, a lower body or waist portion 108, and a bottom recess 110. The pad body 102 may include one or a plurality of slots or holes for receiving a plurality of pad straps, e.g., a first pad strap 112 along and/or through the upper body or chest portion, a second pad strap 114 along and/or through the lower body or waist portion 108, and a third pad strap 116 along and/or through the lower body or waist portion 108. One or a plurality of body or chest straps 117 configured to engage the respective first, second, and third pad straps 112, 114, 116. The ends of the first, second, and third pad straps 112, 114, 116 may be configured as a hook to engage the respective one or a plurality of body or chest straps 117. Straps 112, 114, 116, 117 may include a hook and loop fastener strip (e.g., velcro).

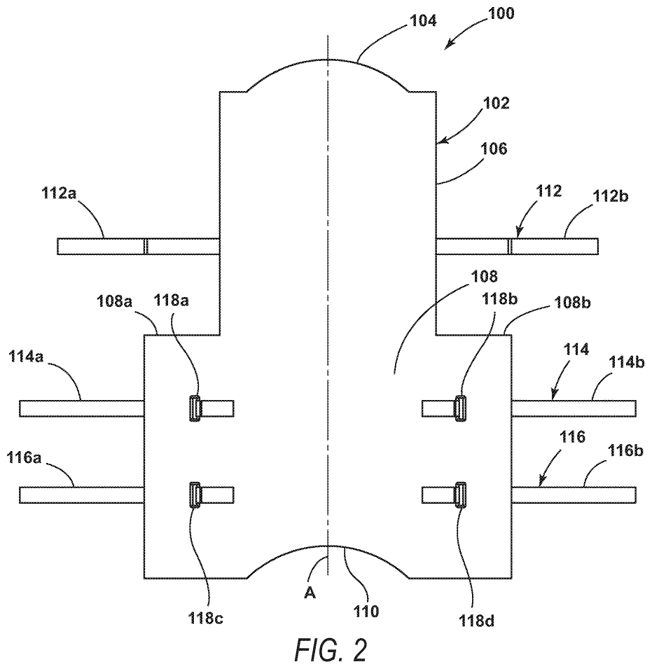

Referring to FIG. 2, the lower body or waist portion 108 may include first and second lower body extensions 108a, 108b (e.g., interchangeably referred to as rear arm extensions 108a, 108b). Lower body portion 108 may include or be attached to lower body extensions 108a, 108b, Lower body extensions 108a, 108b may extend transversely from a central, longitudinal axis A of system 100. Lower body extensions 108a, 108b may be configured to engage a body. e.g., waist, torso, one or both arms of a patient or a combination thereof.

System 100 may include a first buckle 118a on a first portion 114a of the second pad strap 114, a second buckle 118b on a second portion 114b of the second pad strap 114, a third buckle 118c on a first portion 116b of the third pad strap 116, and a fourth buckle 118d on a second portion 116b of the third pad strap 116. The one or a plurality of body or chest straps 117 may be configured to engage and connect respective first and second portions of the first, second, and third pad straps 112, 114, 116.

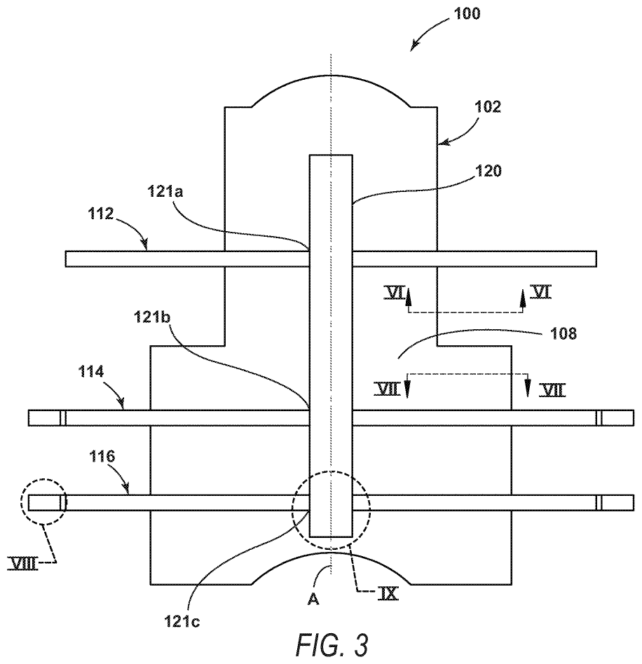

As shown in FIG. 3, system 100 may include support strip 120 attached to the pad. body 102. The support strip 120 may include a tape, e.g., anti-slip tape. The support strip 120 may be positioned transverse to the first, second, and third pad straps 112, 114, 116 and between the pad body 102 and any or all of straps 112 114, 116. Support strip 120 may include a textured surface having a plurality of perforations, ribs, dimples, bumps, or a lattice stricture. Support strip 120 may be configured to increase friction and reduce slip relative to a surgical table. Support strip 120, alone or in combination with any of the straps and/or support strip herein, may be configured to support a substantial portion or majority of the weight of a patient to increase friction and prevent or minimize slippage relative to the surgical table while in Trendelenburg, reverse Trendelenburg, or lateral tilt position.

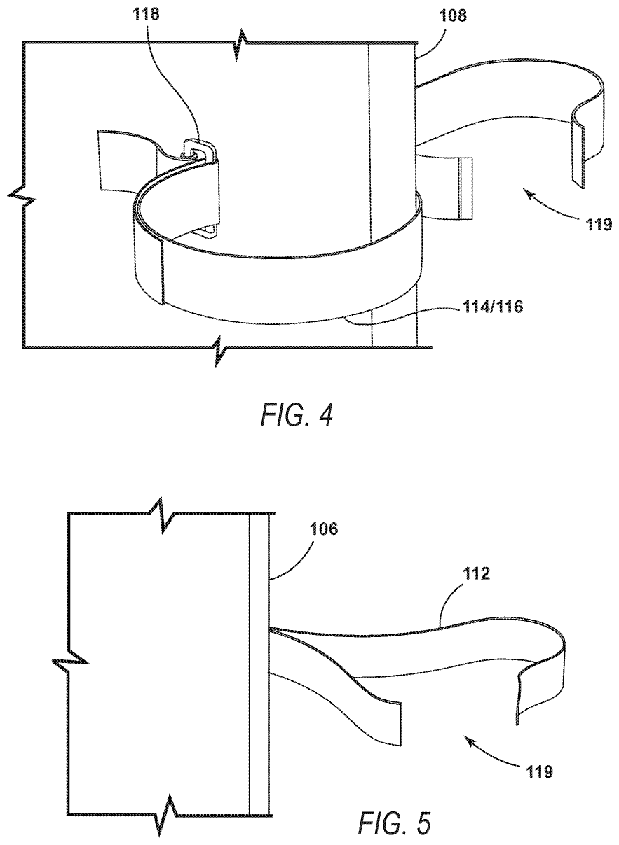

FIG. 4 illustrates system 100 including, for example, a strap and a buckle assembly including strap 114, 116. System 100 may include strap 114, 116 positioned through and about the pad body 102, e.g., lower body or waist portion 108. Straps 114, 116 may further include a hook portion 119 configured to engage the respective one or a plurality of body or chest straps 117.

FIG. 5 illustrates system 100 including, for example, a strap assembly of strap 112. Strap 112 may be secured to the pad body 102, e.g., upper body or chest portion 106. Strip 112 may include hook portion 119 configured to engage the respective one or a plurality of body or chest straps 117.

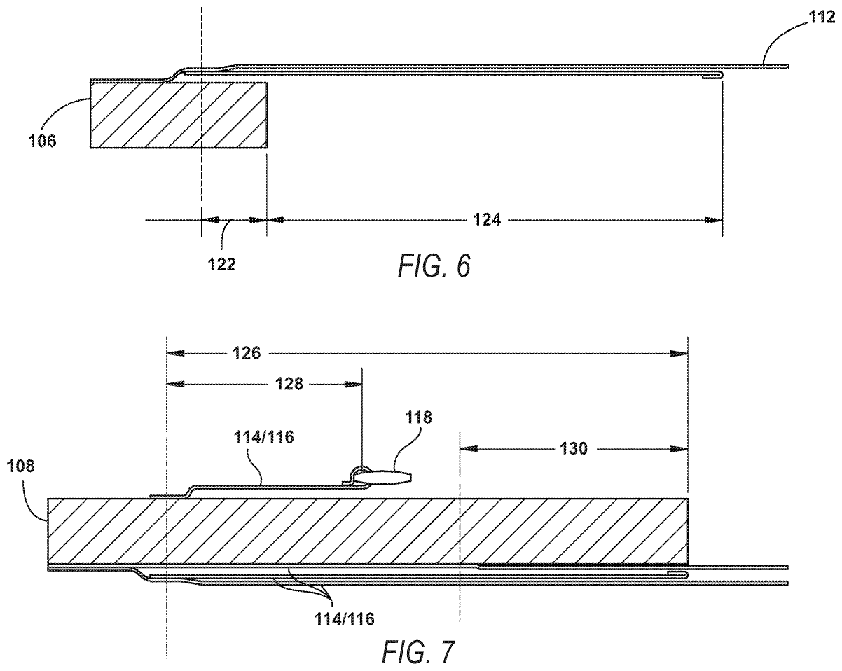

FIG. 6 illustrates strap 112 secured to and/or through the upper body or chest portion 106. Strap 112 may include first and second layers on a front side of upper body or chest portion 106. The first layer may be secured to the upper body or chest portion 106 and positioned along the second layer. The second layer may include a first end secured to an inner side of the first layer and a second end that is folded and hemmed. Strap 112 may include a predefined dimension 122 (e.g., about 1 inch) and a predefined dimension 124 (e.g., about 7 inches). Alternatively or in addition, strap 112 may be secured on or through an upper portion of lower body portion 108, and/or a lower portion of lower body portion 108.

FIG. 7 illustrates strap 114, 116 secured to and/or through lower body or waist portion 108. Strap 114, 116 may include a first layer on a front side of lower body or waist portion 108 and second third and fourth layers on a back side of lower body or waist portion 108. The first layer may include a first end secured to a front side of the lower body or waist portion 108. The second layer may be secured along the back side of lower body or waist portion 108. The third layer may be positioned between the second layer and the third layer. The fourth layer may include a first end secured to the second layer, a middle portion secured to the third layer, and may extend along the third layer. Strap 114, 116 may include a predefined dimension 126 (e.g., about 8 inches), a predefined dimension 128 (e.g., about 3 inches), and a predefined dimension 130 (e.g., about 3.5 inches). Alternatively or addition, straps 114, 116 may be secured to and/or through upper body or waist portion 106.

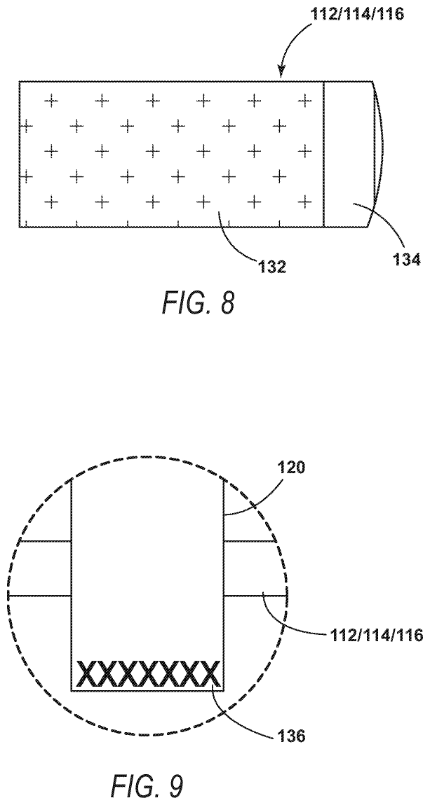

FIGS. 8-10 illustrate closer views of the straps herein. As shown in FIG. 8, strap 112, 114, 116 may include stitch pattern 132 securing strap 112, 114, 116 to hook and loop fastener 134. With reference to FIG. 9, strap 112, 114, 116 may be positioned under tape 120 and with tape 120 having stitch pattern 136 on one or both sides thereof.

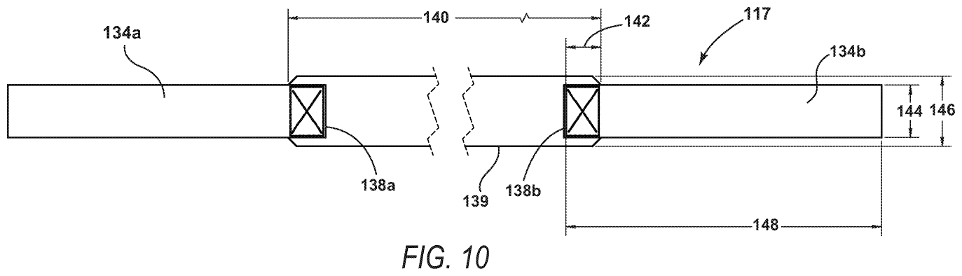

Referring to FIG. 10, strap 117 may include first and second strap portions 134a, 134b (e.g., with a fastener layer), stitch patterns 138a, 138b, and middle portion 139. Strap 117 may include a predefined dimension 140 (e.g., about 60 inches), a predefined dimension 142 (e.g., about 1 inch), a predefined dimension 144 (e.g., about 1.5 inches), a predefined dimension 146 (e.g., about 2 inches), and a predefined dimension 148 (e.g., about 9 inches).

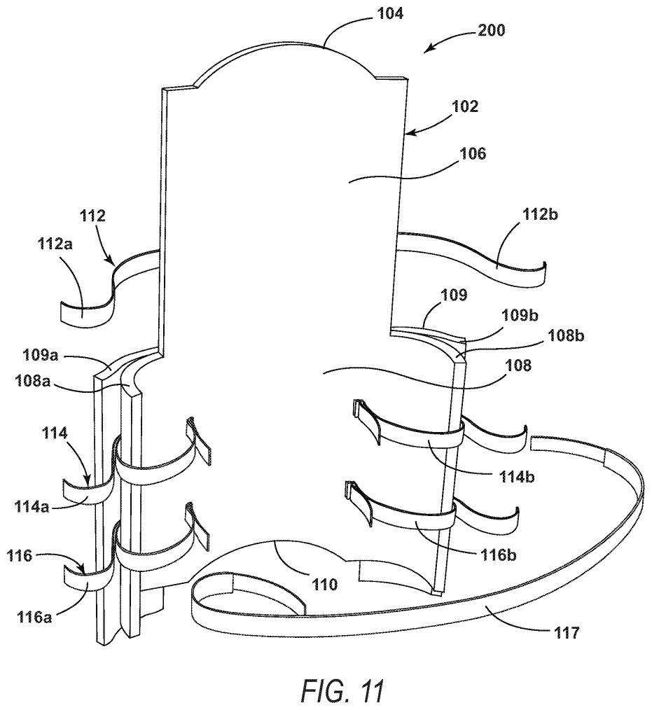

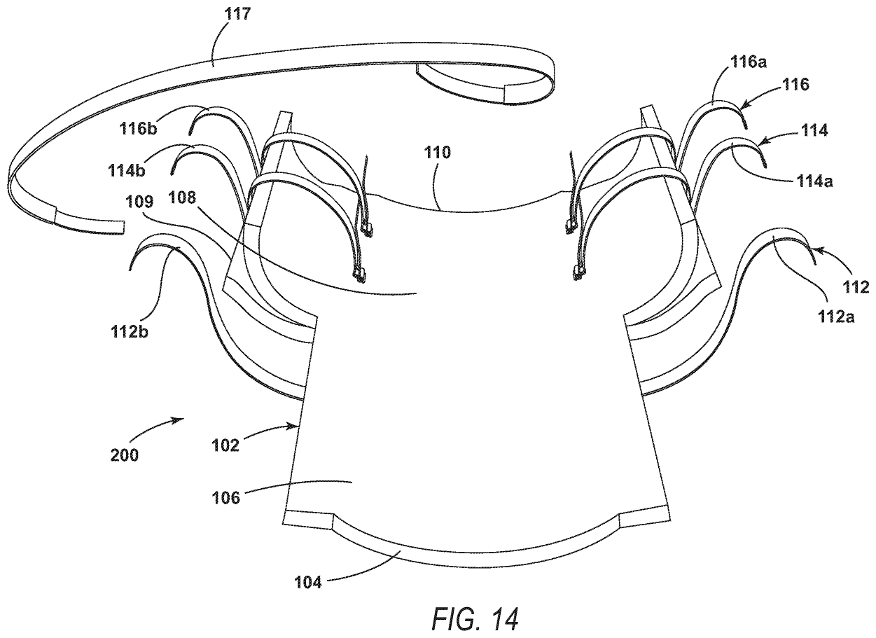

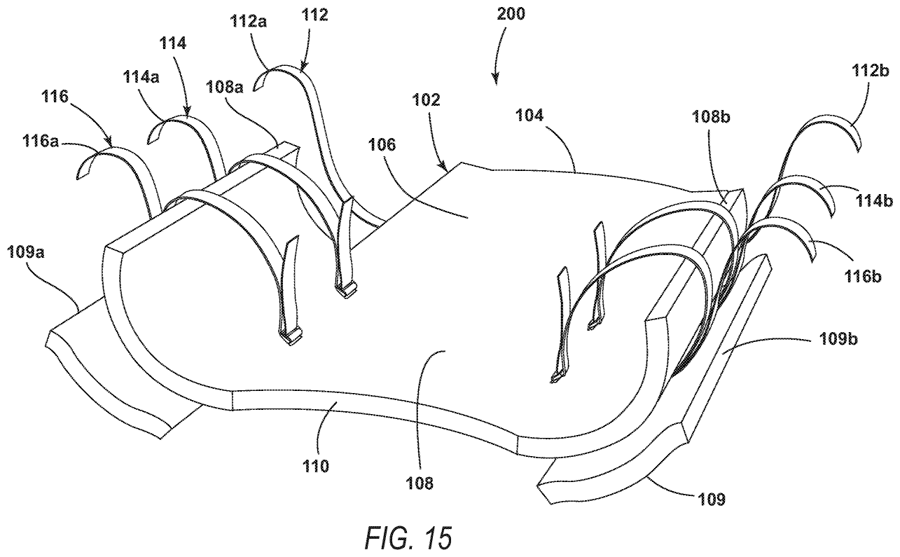

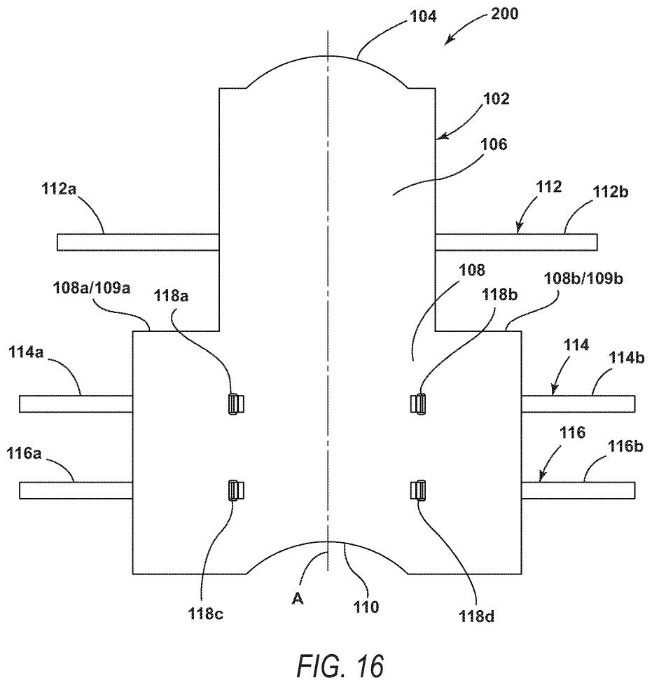

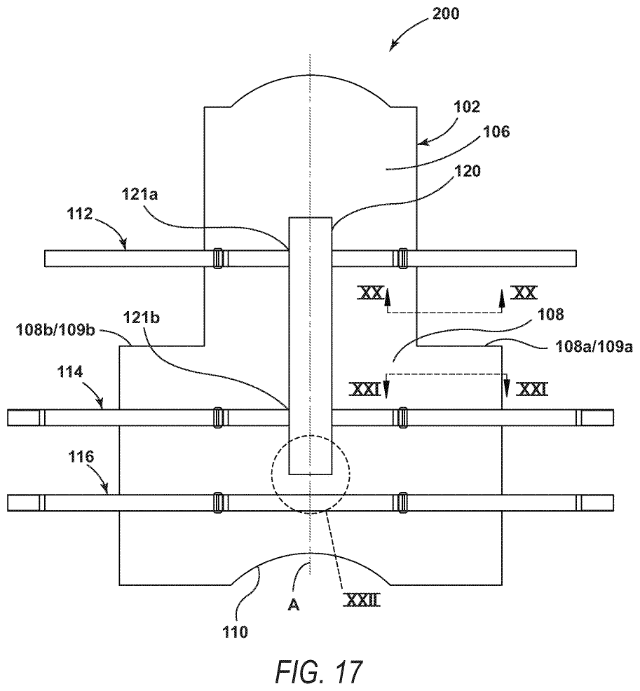

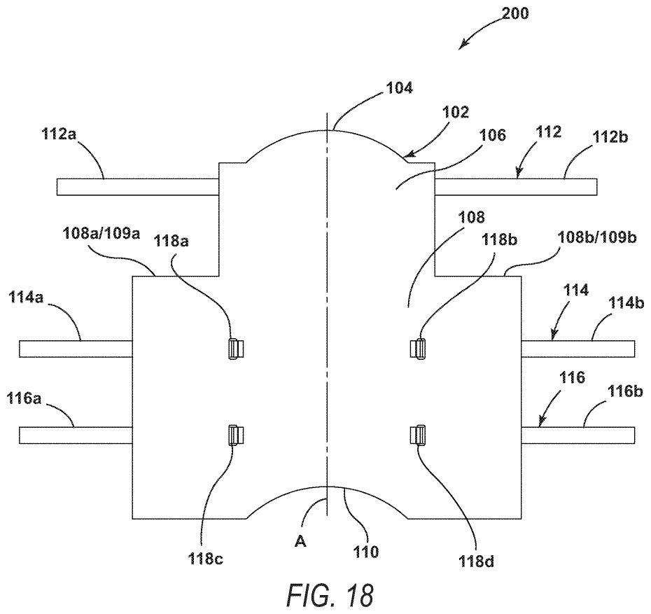

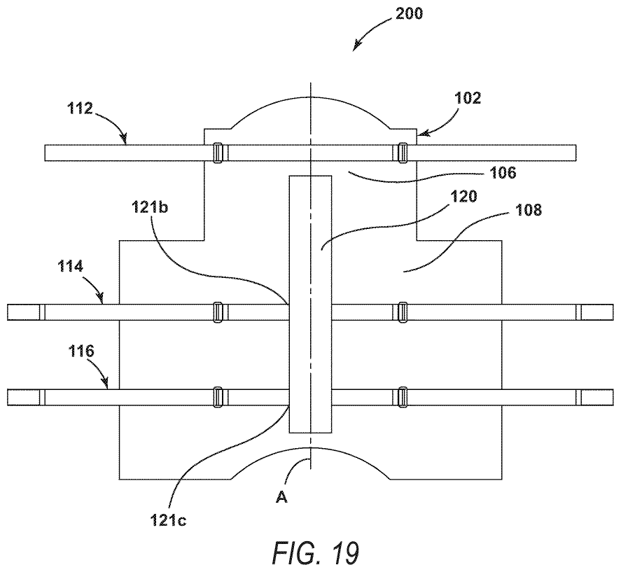

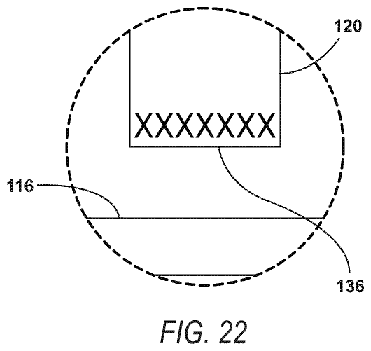

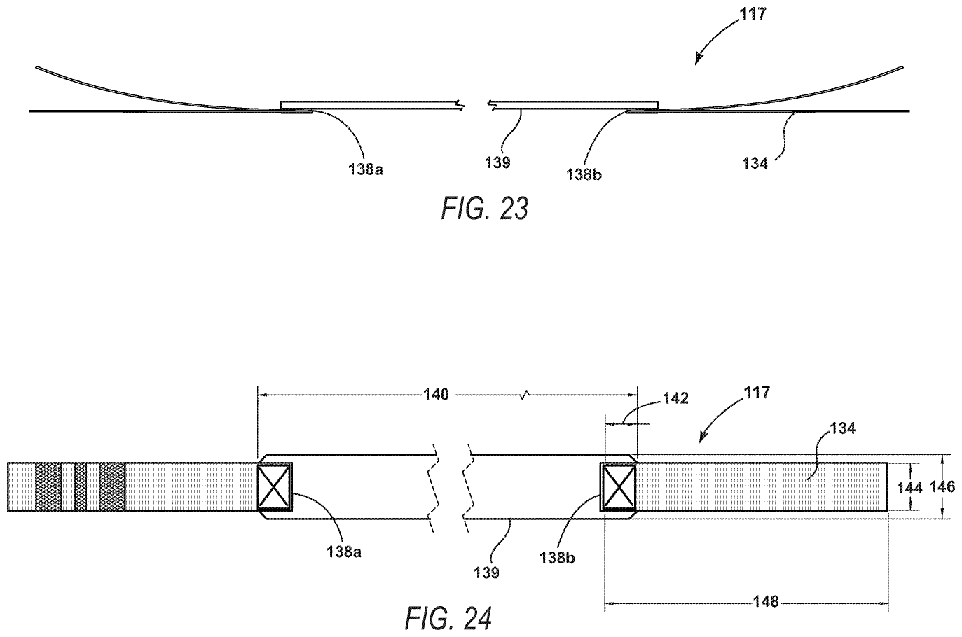

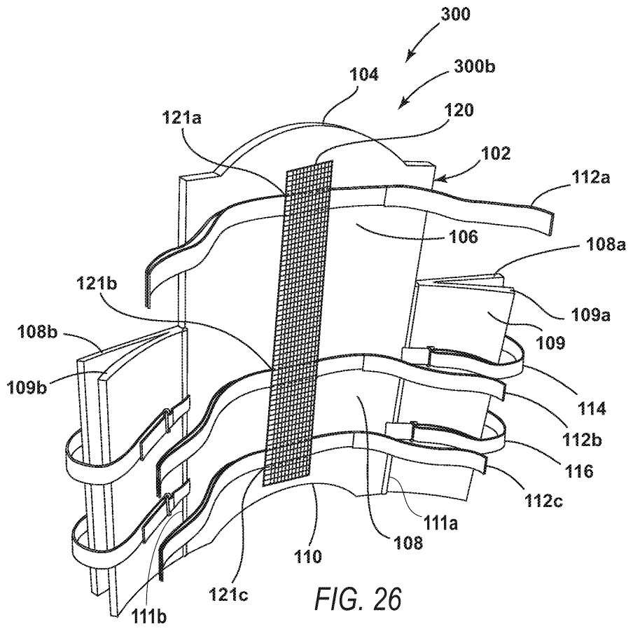

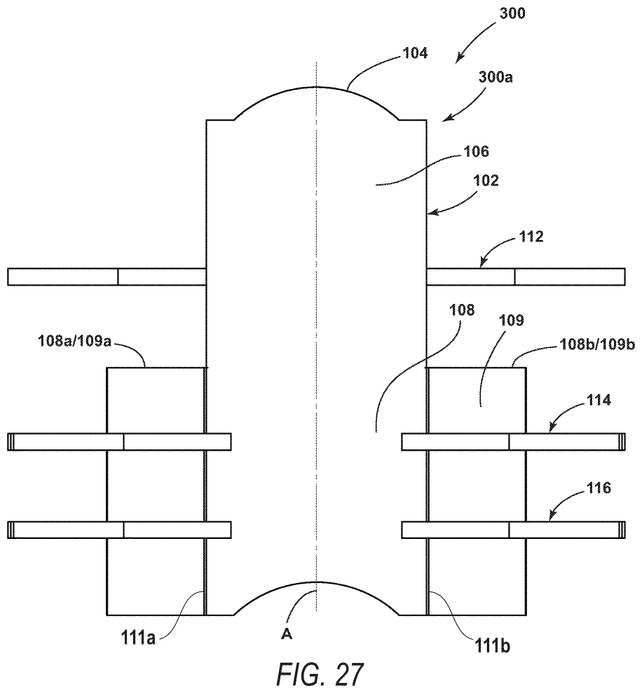

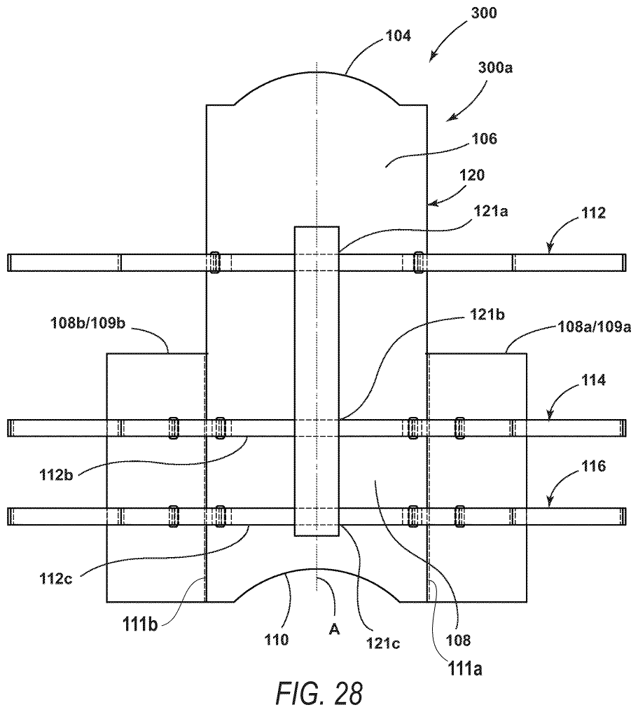

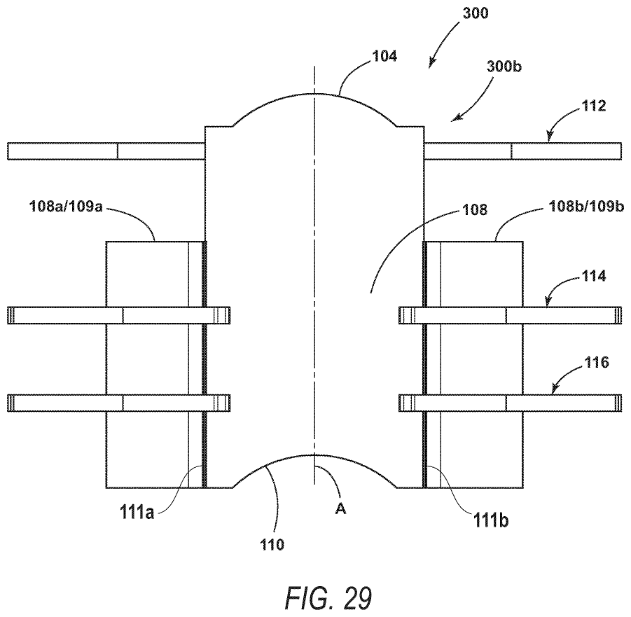

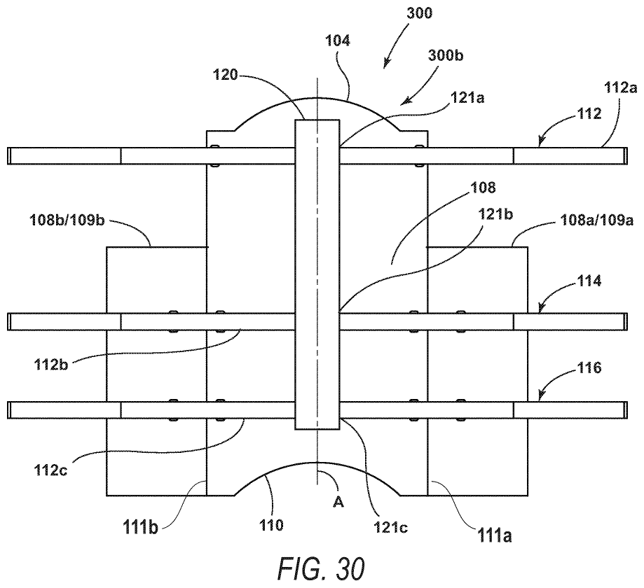

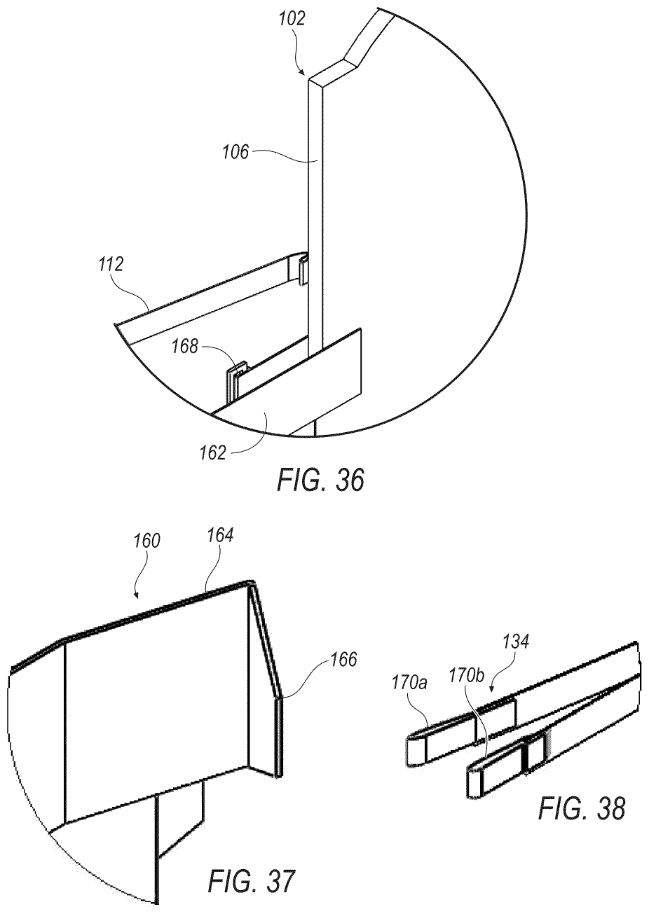

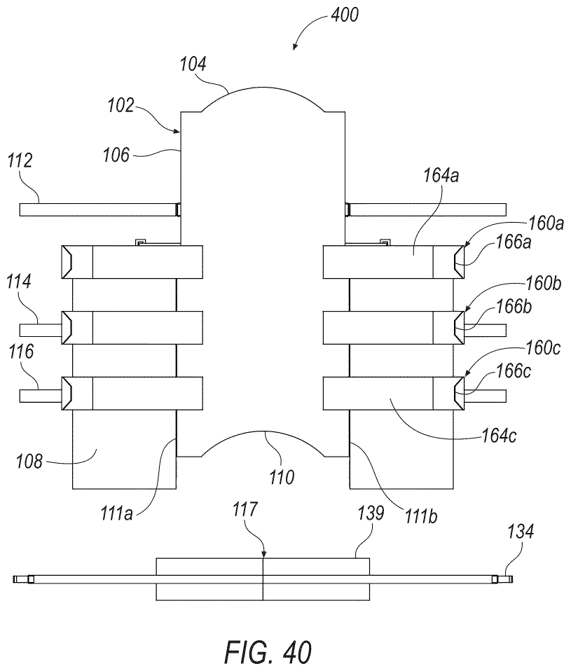

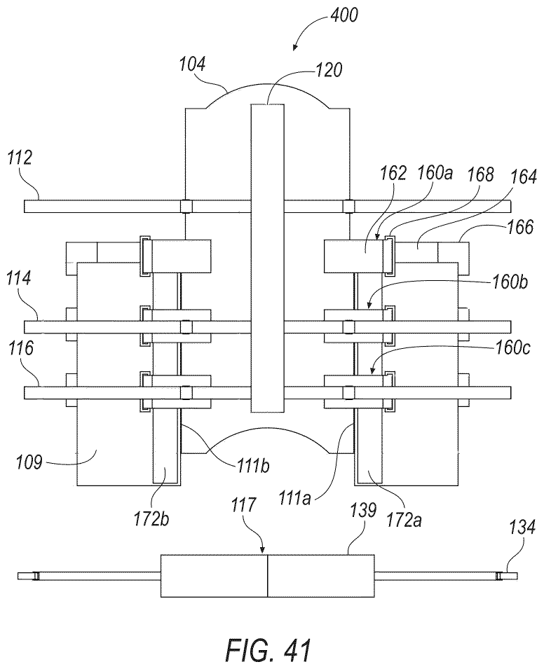

FIGS. 11-24 illustrate system 200 that may include all or any portions of systems 100, 300, and/or 400 as described with respect to FIGS. 1-10 and 25-41. As shown in FIGS. 11-24, system 200 may include similar or different structures and components than systems 100, 300, and/or 400. System 200 may include a pad body 102. Pad body 102 may be made of a flexible material such as foam, e.g., medical grade foam.

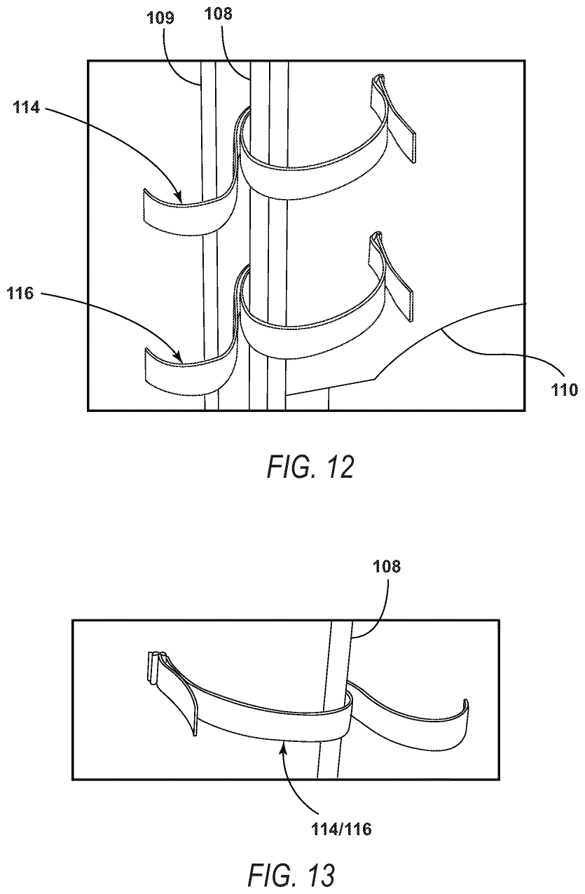

FIGS. 12-13 illustrate straps 114, 116 secured to and through lower body portion 108 and between lower body portion 108 and arm support 109. Straps 112 may be similarly secured to and through upper body portion 106.

As shown in FIGS. 11 and 14-19, pad body 102 may include an upper extension 104, an upper body or chest portion 106, a lower body or waist portion 108, and a bottom recess 110. The pad body 102 may include one or a plurality of slots or holes for receiving, a first pad strap 112 along and/or through the upper body or chest portion, a second pad strap 114 along and/or through the lower body or waist portion 108, and a third pad strap 116 along and/or through the lower body or waist portion 108.

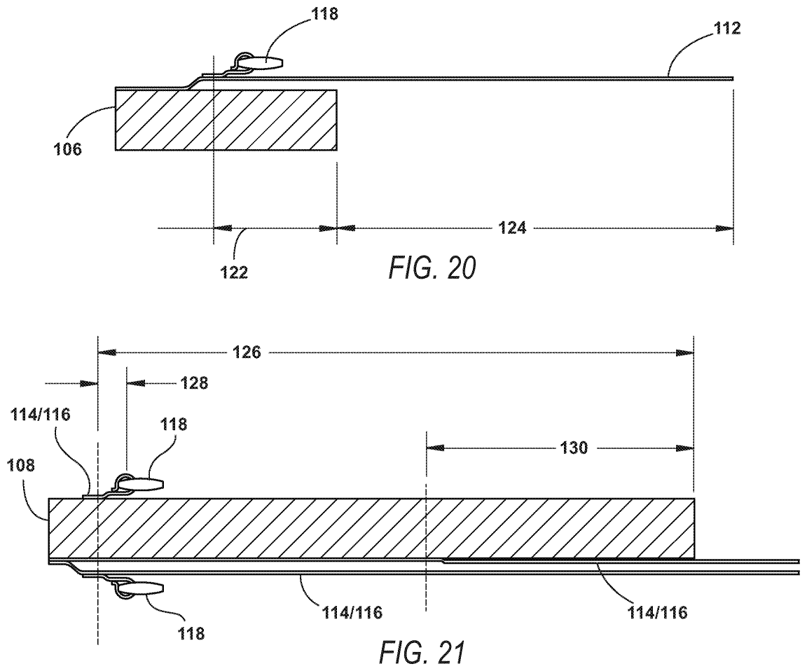

FIGS. 20-22 illustrate another arrangement of the components described above with respect to FIGS. 6-9, and FIGS. 23-24 illustrate another arrangement of the components described above with respect to FIG. 10. One or a plurality of body or chest straps 117 may be configured to engage the respective first, second, and third pad straps 112, 114, 116. The ends of the first, second, and third pad straps 112, 114, 116 may be configured as a hook to engage the respective one or a plurality of body or chest straps 117.

System 200 may include lower body portion 108 and arm portions or supports 109. Lower body portion 108 may include lower body extensions 108a 108b. Arm extensions 109a, 109b (e.g., interchangeably referred to as front arm extensions 109a, 109b) may have a similar material and construction as lower body extensions 108a, 108b. The first and second arm extensions 109a, 109h may be positioned on respective sides of lower body portion 108 and configured to engage corresponding lower body extensions 108a, 108b. Arm extensions 109a, 109b may be in an corresponding arrangement to respective lower body extensions 108a, 108b so as to wrap or encompass the entire arm of the patient while allowing access to the shoulders and hands of the patient for injections, intravenous fluids and patient monitoring.

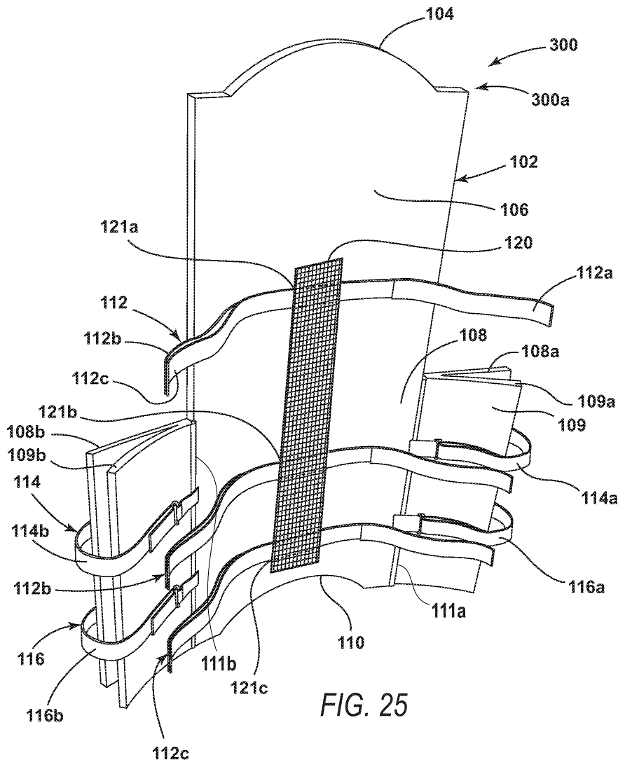

FIGS. 25-34 illustrate system 300 that may include all or any portions of systems 100, 200, and/or 300 as described with respect to FIGS. 1-24 and 35-41. As shown in FIGS. 25-34, system 300 may include similar or different structures and components than systems 100, 200, and/or 300. System 300 may include a pad body 102. Pad body 102 may be made of a flexible material such as foam, e.g., medical grade foam.

With further reference to FIGS. 25-30, system 300 may include pad body 102 having an upper extension 104, an upper body or chest portion 106, a lower body or waist portion 108, arm portions 109, and a bottom recess 110. FIGS. 25 and 27-28 include system 300a, having an elongated or longer length along longitudinal axis A and FIGS. 25 and 29-30 include system 300b having a compact or shorter length along longitudinal axis A.

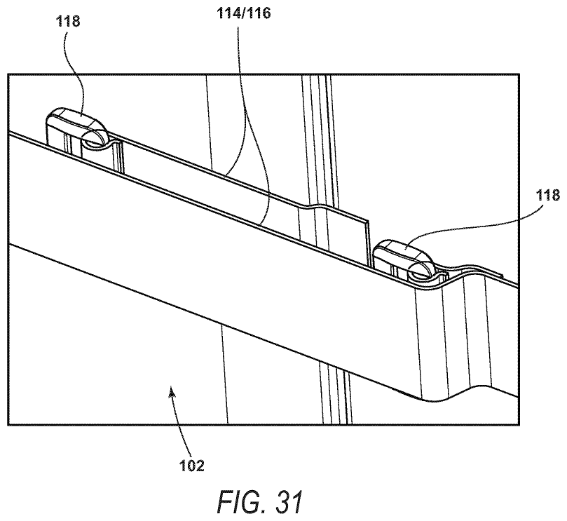

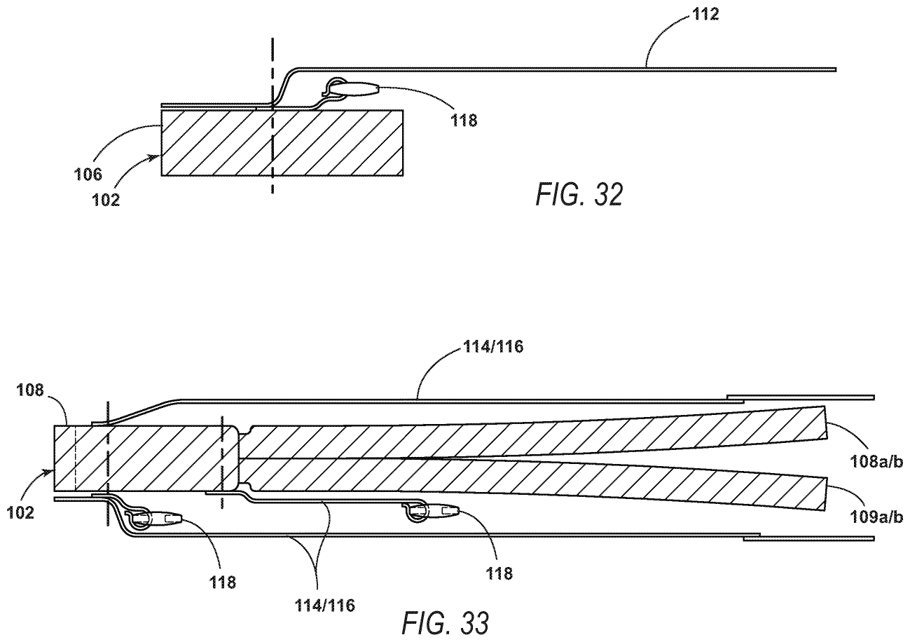

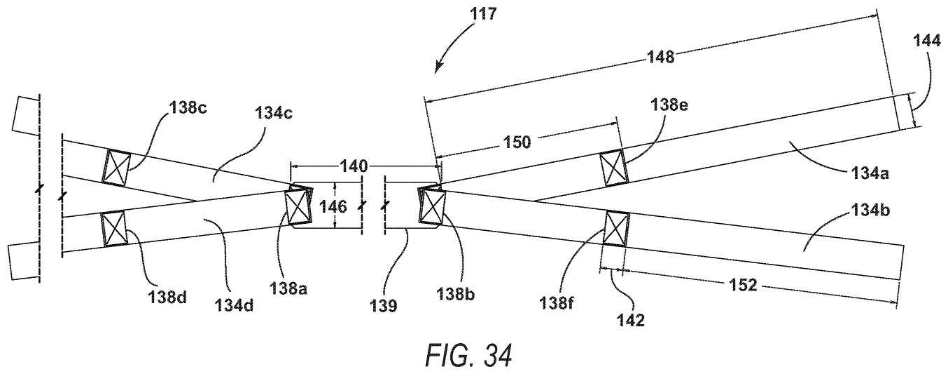

System 300 may include pad straps 112a, 122b, 112c, 114, 116 as shown in FIGS. 25-33 and one or more body strap 117 as shown in FIG. 34 to engage any of pad straps 112a, 122b, 112c, 114, 116 and/or a surgical table. Referring to FIG. 31, buckles 118 may be positioned on respective pad straps 114, 116. FIG. 32 includes a strap and buckle assembly haying buckle 118 positioned on pad strap 112 that is secured to upper body potion 106. With reference to FIG. 33, buckles 118 may be positioned on respective portions of pad straps 114, 116.

As shown in FIG. 34, strap 117 may include strap portions 134a-d, stitch patterns 138a-f on corresponding strap portions 134, and middle potion 139 having a first end with strap portions 138a, 138b at a first angle relative to each other and a second end with strap portions 138c, 138d at the first or a second angle relative to each other. Strap 117 may include a predefined dimension 140 (e.g., about 20 inches), a predefined dimension 142 (e.g., about 1 inch), a predefined dimension 144 (e.g., about 1.5 inches), a predefined dimension 146 (e.g., about 2 inches), a predefined dimension 148 (e.g., about 20 inches), and a predefined dimension 150 (e.g., about 8 inches), and a predefined dimension 152 (e.g., about 12 inches).

The pad body 102 may include one or a plurality of slots or holes for receiving one or a plurality of pad and/or body straps, e.g., a first pad strap 112 along and/or through the upper body or chest potion, a second pad strap 114 along and/or through the lower body or waist portion 108, and a third pad strap 116 along and/or through the lower body or waist portion 108. One or a plurality of body or chest straps 117 configured to engage the respective first, second, and third pad straps 112, 114, 116, side rails of a surgical table, or any combination thereof. The ends of the first, second, and third pad straps 112, 114, 116 may be configured as a hook to engage the respective one or a plurality of body or chest straps 117 side rails of the surgical table, or any combination thereof. The system 300 may include support strip 120.

Any of systems 100, 200, 300, and/or 400 may be configured as a positioning system for securing a patient relative to a surgical table. A system may include a pad body 102, an upper body portion 106 with an upper extension 104, a lower body portion 108 with first and second lower body or rear arm extensions 108a, 108b, first and second arm or front arm extensions 109a, 109b corresponding to the respective first and second lower body extensions 108a, 108b, and a bottom recess in the lower body portion 110. The system may include a first pad strap 112 configured to be positioned through the upper body portion 106, a second pad strap 114 configured to be positioned through an upper portion of the lower body portion 108, and a third pad strap 116 configured to be positioned through a lower portion of the lower body portion 108. The system may include a plurality of body straps 117 configured to engage at least one of the first, second, and third pad straps 112, 114, 116 and side rails of the surgical table. The first and second lower body extensions 108a 108b may be configured to be positioned between a waist of a patient and respective first and second arms of the patient. The first arm extension 109a and first lower body extension 108a may be configured to wrap around the first arm of the patient, and the second arm extension 109b and second lower body extension 108b are configured to wrap around the second arm of the patient. The system may include a plurality of buckles 118 on corresponding pad straps 112, 114, 116 or body straps 117.

The system may include support strip 120. The support strip 120 may be attached to the pad body 102. The support strip 120 may be positioned along a central, longitudinal axis A of the pad body. The support strip 120 may form channels or passages 121 relative to the pad body 102. Channels 121 may be configured to receive at least one of the first, second and third pad straps 112, 114, 116 between the pad body 102 and the support strip 120. The support strip 120 may be configured to support a substantial portion of a weight of a patient. The support strip 120 may include an anti-slip tape. The support strip may be attached along a central, longitudinal axis A of the pad body 102 and transverse to the first, second, and third pad straps 112, 114, 116. Any of the plurality of body straps 117 or pad straps 112, 114, 116 may include a fastening side with a hook and loop fastener configured to engage itself or another one of the plurality of body straps 117 or pad straps 112, 114, 116.

The system may be configured for engagement between the first and second arm extensions 109a, 109b and the first and second lower body extensions 108a, 108b. This engagement, alone or in conjunction with the straps and support strip 120, may be configured to support a substantial portion or majority of a weight of the patient to resist slippage relative to a surgical table while in at least one of a Trendelenburg, reverse Trendelenburg, or lateral tilt position.

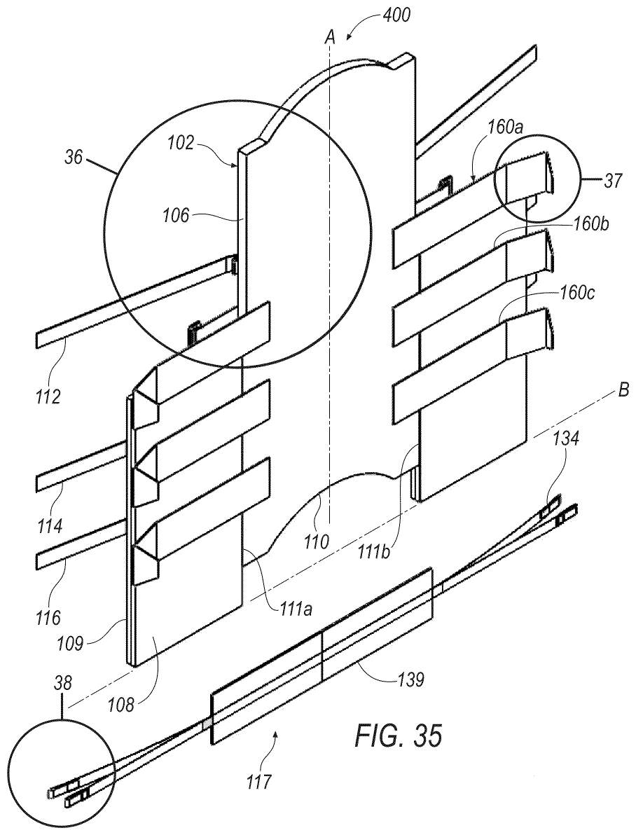

FIGS. 35-41 illustrate system 400 that may include all or any portions of systems 100, 200 and/or 300 as described with respect to FIGS. 1-34. System 400 stray include similar or different structures and components than systems 100, 200, and/or 300. Embodiments may be configured for dimensional adjustability, electrosurgical grounding, temperature control, and/or volume inflatability, e.g., on or as part of the top side, bottom side, and/or sidewalls of pad body 102. Embodiments may include integrated and/or adjustable rear and front arm extensions 108, 109 relative to pad body 102, e.g., adjustable along the longitudinal and/or transverse axes. Embodiments may include temperature controls including heating and/or cooling elements. Embodiments may include a gel pad with electrical grounding and/or temperature controls. Embodiments may include a grounding electrode on or as part of pad body 102. Embodiments may include an inflatable pad on or as part of pad body 102, e.g., that can be inflated for use or deflated for transportation. Any of the components disclosed herein may be integrated, detachable, reusable, and/or disposable.

System 400 may include pad body 102 having upper extension 104, upper body portion 106, lower body portion 108, and bottom recess 110. System 400 may include rear and front arm extensions 109a, 108a (e.g., a first pair) extending along each other and from the pad body in a direction relative to the longitudinal axis. System 400 may include rear and front arm extensions 109a, 108b extending along each other and from the pad body in a second direction relative to the longitudinal axis A. The and second directions may oppose each other relative to the longitudinal axis A.

Lower body portion 108 may include transverse ends 111a, 112b on opposing first and second sides of longitudinal axis A. Transverse ends 111a, 112b may include outwardly facing edges of pad body 102. Transverse ends 111a 112b may be respectively parallel to and/or shared with inwardly facing edges of rear and front arm extensions 108a, 109a on the first side and extensions 108b 109b on the second side. Rear and front arm extensions 108, 109 may or a common edge or end connected to pad body 102.

First, second, and third arm straps 160a, 160b, 160c may be configured to wrap around extensions 108a, 109a on the first side and extensions 1081, 109b on the second side, e.g., the first, second, and third arm straps 160a, 160b, 160c having distal and proximal portions having hook and loop fasteners secured to each other in an overlapping, folded, and/or opposing configuration. Extensions 108a, 109a may be configured to be positioned around opposing sides of a first arm of a patient and extensions 108b, 109b may be configured to be positioned opposing sides of a second arm of the patient.

System 400 may include pad body 102, first, second, and third pad straps 112, 114, 116, first, second, and third arm straps 160a, 160b, 160c, one or more body straps 117, and support strip 120. As shown in FIGS. 35 and 38, strap 117 may include strap portions 134 including first and second loops 170a, 170b. Pad body 104 may have longitudinal axis A and first and second transverse ends on opposing sides of longitudinal axis A. Pad body 104 may include an upper body portion 106 with an upper extension, a lower body portion 108 having first and second lower body extensions 108a, 108b, first and second arm extensions 109a, 109b corresponding to the respective first and second lower body extensions 108a, 108b, bottom recess 110 in lower body portion 108, or a combination thereof. The first, second, and third pad straps 112, 114, 116 may be configured to be respectively positioned through the upper and/or lower body portions 106, 108. The plurality of body straps 117 may be configured to engage at least one of the first, second, and/or third pad straps 112, 114, 116. Support strip 120 may be attached to the pad body 102 and form channels to receive at least one of the first, second and/or third pad straps 112, 114, 116 between the pad body 102 and the support strip 120.

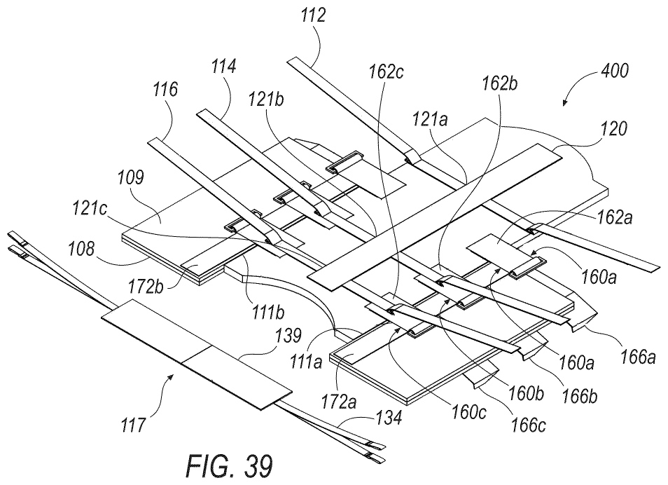

A positioning system may include pad body 102 having longitudinal axis A, a rear side, and a front side. As shown in FIG. 39, pad body 102 may include first and second longitudinal adjustment strips 172a, 172b. First and second longitudinal adjustment strips 172a, 172b may be positioned on the rear side of pad body 102 and respectively adjacent the first and second transverse ends 111a, 111b.

Embodiments may include a first pair of arm extensions (e.g., first rear and front arm extensions) adjustably extending from the first longitudinal adjustment strip and along each other in a first direction relative to the longitudinal axis. Embodiments may further include a second pair of arm extensions (e.g., second rear and front arm extensions) adjustably extending from the second longitudinal adjustment strip and along each other in a second direction relative to the longitudinal axis. The first pair of arm extensions 108a, 109a may be configured to partially separate from each other and wrap around a first arm of a patient, and the second pair of arm extensions 108b, 109b may be configured to partially separate from each other and wrap around a second arm of a patient. First and second longitudinal adjustment strips 172a, 172b may be configured to respectively adjust a longitudinal position of the first and second pairs of arm extensions 108a, 108b, 109a, 109b substantially parallel to the longitudinal axis A. Pad body 102 may include at least one of a temperature control element or an electrical grounding electrode. Pad body 102 may include at least one of a gel pad or an inflatable pad.

Embodiments may include first, second, and third arm straps 160a, 160b, 160c configured to wrap around the first pair of arm extensions 108a, 109a on the first side and the second pair of arm extensions 108b, 109b on the second side. Embodiments may include first, second, and third pad straps 112, 114, 116 configured to be positioned on or through the pad body. Embodiments may include a plurality of body straps 117 configured to engage at least one of the first, second, and third pad straps 112, 114, 116. First, second, and third arm straps 160a, 160b, 160c may include proximal end 162, strap body 162, distal end 166, and buckles 168.

Embodiments may include support strip 120 attached to the rear side of pad body 102 and along the longitudinal axis A. Support strip 120 may be positioned transverse to the first, second, and third pad straps 112, 114, 116. Support strip 120 may be configured to receive at least one of the first, second and third pad straps 112, 114, 116 between pad body 102 and support strip 120.

Methods of providing and using systems 100, 200, 300, and 400 are contemplated. The method may include providing the system in a folded configuration having, e.g., with upper body portion 106 folded over lower body portion 108 about a transverse fold and lower body portion 108 and arm extensions 109 over lower body portion 108 with longitudinal folds. The method may further include placing the system in the folded configuration on a surgical table aligning bottom recess 110 with an edge of the table, centering the system on the table, and unfolding portions 114 and 116 on the table. The method may include engaging pad straps 112, 114, and/or 116 through the side rails of the table and engaging pad straps 112, 114, and/or 116 through one or more buckles 118 on a back or table facing side of the system. The method may include unfolding lower body portions 108a, 108b and arm extensions 109a, 109b wrapping lower body portions 108a, 108b and arm extensions 109a, 109b around the mms of the patient and each other, and engaging pad straps 112, 114 and/or 116 around the respective lower body portions 108a, 108b and arm extensions 109a, 109b. The method may include positioning body straps 117 over the body and arms of the patient and engaging body straps 117 to the side rails of the table or pad straps 112, 114, 116. The method may include tilting the table to a prescribed. angle for the medical procedure while the system restricts or prevents movement of the patient relative to the table. Methods may include a combination of any or all of these steps.

It will be appreciated that the aforementioned method and devices may be modified to have some components and steps removed, or may have additional components and steps added, all of which are deemed to be within the spirit of the present disclosure. None of the components or steps herein are essential elements nor is their interdependency required. Even though the present disclosure has been described in detail with reference to specific embodiments, it will be appreciated that the various modifications and changes can be made to these embodiments without departing from the scope of the present disclosure as set forth in the claims. The specification and the drawings are to be regarded as an illustrative thought instead of merely restrictive thought.

What is claimed is:

1. A positioning system comprising:
a pad body having a longitudinal axis, a rear side, a front side, and first and second transverse ends on opposing sides of the longitudinal axis, wherein the pad body includes first and second longitudinal adjustment strips on the rear side and respectively adjacent the first and second transverse ends;
a first pair of arm extensions adjustably extending from the first longitudinal adjustment strip and along each other in a first direction relative to the longitudinal axis; and
a second pair of arm extensions adjustably extending from the second longitudinal adjustment strip and along each other in a second direction relative to the longitudinal axis.

2. The positioning system of claim 1, wherein the first pair of arm extensions includes first rear and front arm extensions configured to partially separate from each other and wrap around a first arm of a patient, and the second pair of arm extensions includes second rear and front arm extensions configured to partially separate from each other and wrap around a second arm of a patient.

3. The positioning system of claim 1, wherein the first and second longitudinal adjustment strips are configured to respectively adjust a longitudinal position of the first and second pairs of arm extensions substantially parallel to the longitudinal axis.

4. The positioning system of claim 1, wherein the pad body includes at least one of a temperature control element or an electrical grounding electrode.

5. The positioning system of claim 1, wherein the pad body includes at least one of a gel pad or an inflatable pad.

6. The positioning system of claim 1, further comprising at least one of
first, second, and third arm straps configured to wrap around the first pair of arm extensions on the first side and the second pair of arm extensions on the second side;
first, second, and third pad straps configured to be positioned through the pad body;
a plurality of body straps configured to engage at least one of the first, second, and third pad straps; and
first and second buckles on the second pad strap and third and fourth buckles on the third pad strap.

7. The positioning system of claim 6, further comprising a support strip attached to the rear side of the pad body and along the longitudinal axis, wherein the support strip is positioned transverse to the first, second, and third pad straps and configured to receive at least one of the first, second and third pad straps between the pad body and the support strip.

8. A positioning system comprising:
a pad body having first and second longitudinal adjustment strips;
first rear and front arm extensions adjustably extending from the first longitudinal adjustment strip and along each other; and
second rear and front arm extensions adjustably extending from the second longitudinal adjustment strip and along each other.

9. The positioning system of claim 8, wherein the first rear and front arm extensions are configured to partially separate from each other and wrap around a first arm of a patient, and the second rear and front arm extensions are configured to partially separate from each other and wrap around a second arm of a patient.

10. The positioning system of claim 8, wherein the first and second longitudinal adjustment strips are configured to respectively adjust a longitudinal position of the first rear and front arm extensions and the second rear and front arm extensions.

11. The positioning system of claim 8, wherein the pad body includes at least one of a temperature control element or an electrical grounding electrode.

12. The positioning system of claim 8, wherein the pad body includes at least one of a gel pad or an inflatable pad.

13. The positioning system of claim 8, further comprising at least one of
first, second, and third arm straps configured to wrap around the first rear and front arm extensions on the first side and the second rear and front arm extensions on the second side;
first, second, and third pad straps configured to be positioned through the pad body;
a plurality of body straps configured to engage at least one of the first, second, and third pad straps; and
first and second buckles on the second pad strap and third and fourth buckles on the third pad strap.

14. The positioning system of claim 13, further comprising a support strip positioned transverse to the first, second, and third pad straps and configured to receive at least one of the first, second and third pad straps between the pad body and the support strip.

15. A method of using a positioning system, the method comprising:
providing a pad body having first and second longitudinal adjustment strips;
providing first rear and front arm extensions adjustably extending from the first longitudinal adjustment strip and along each other; and
providing second rear and front arm extensions adjustably extending from the second longitudinal adjustment strip and along each other.

16. The method of claim 15, wherein the first rear and front arm extensions are configured to partially separate from each other and wrap around a first arm of a patient, and the second rear and front arm extensions are configured to partially separate from each other and wrap around a second arm of a patient.

17. The method of claim 15, wherein the first and second longitudinal adjustment strips are configured to respectively adjust a longitudinal position of the first rear and front arm extensions and the second rear and front arm extensions.

18. The method of claim 15, wherein the pad body includes at least one of a temperature control element or an electrical grounding electrode.

19. The method of claim 15, wherein the pad body includes at least one of a gel pad or an inflatable pad.

20. The method of claim 15, further providing at least one of:
first, second, and third arm straps configured to wrap around the first rear and front arm extensions on the first side and the second rear and front arm extensions on the second side;
first, second, and third pad straps configured to be positioned through the pad body;
a plurality of body straps configured to engage at least one of the first, second, and third pad straps; and
first and second buckles on the second pad strap and third and fourth buckles on the third pad strap.
